(19) United States
(12) Patent Application Publication
(10) Pub. No.: US 2025/0246092 A1
(43) Pub. Date: Jul. 31, 2025

(54) Articulated Motion Simulator

(71) Applicant: Steven Jones, Carson City, NV (US)

(72) Inventor: Steven Jones, Carson City, NV (US)

(73) Assignee: Franklin Trust, Carson City, NV (US)

(21) Appl. No.: 18/423,252

(22) Filed: Jan. 25, 2024

(51) Int. Cl. G09B 9/02

(52) U.S. Cl. CPC G09B 9/02

(57) ABSTRACT

A highly dynamic motion simulator comprised of an occupant platform 22 which is supported and articulated between two vertically oriented multi-axis translation mechanisms 21 and 23. The five degrees of freedom embodiment produces motion with five degrees of freedom (FIG. 1). The six degrees of freedom embodiment adds a longitudinal translation assembly which produces motion with six degrees of freedom (FIG. 2). This design minimizes inertial mass providing high dynamic performance.

### TECHNICAL FIELD

This machine generates motion for aerospace, marine, and vehicle simulation.

### PRIOR ART

Full motion simulator designs are dominated by the Stewart base and its derivatives. The Stewart base is a parallel robotic mechanism combining six linear actuators. Advantages of parallel mechanisms include large payload capacity, good dynamic speed, and end-effector stiffness. The primary disadvantage is the limited range of translation available if any significant amount of rotation is needed simultaneously.

Auto manufacturers construct large driving simulators for development and testing. Several auto manufacturers have attached Stewart bases on top of large floor mounted horizontal x-y translation platforms. Advantages include high performance rotation from the Stewart base, and large amounts of horizontal translation. Disadvantages may include slow translation speed. “Swinging around” a Stewart base requires a massive x-y platform. These large simulators typically have total inertial mass totaling hundreds of kilograms. This accumulated mass limits dynamic performance.

Breaking free from the Stewart base convention is the Desdemona Simulator (Desdemona BV, Netherlands). This simulator is comprised of a three axis gimbal pilot capsule combined with 2 meters of vertical, and 8 meters of longitudinal translation. The pilot capsule provides unlimited roll, pitch, and yaw. The pilot capsule and translation mechanism are mounted on a large rotatable centrifuge platform. The Pentagon operates a version of the Desdemona called the “Kraken” at Wright-Patterson Air Force Base.

The Desdemona Simulator impressively fulfills specific aerospace simulation tasks. However, its necessarily specialized design reduces its usefulness as a general purpose simulator. Three axis gimbal assemblies are subject to gimbal lock. The Desdemona is not immune to this. In addition to gimbal lock, the Desdemona has limited translation dynamics when the pilot capsule is in specific orientations. When the pilot is rotated laterally aligning with the longitudinal track, surge motion relative to the pilot (forward direction) becomes limited by the acceleration and deceleration ability of the entire inertial mass of the centrifuge structure. When the pilot is rotated longitudinally aligning with the longitudinal track, sway motion relative to the pilot is severely limited.

### SUMMARY OF THE EMBODIMENTS

The five degrees of freedom embodiment is shown in FIG. 1. This machine produces motion with five degrees of freedom. The occupant platform has multi-axis pivot joints located at its longitudinal endpoints. These joints connect to two vertically oriented x-y translation mechanisms. The occupant platform is supported and articulated by these mechanisms. Unlimited 360 degree roll rotation is possible. Maximum pitch and yaw rotation is +/−40 degrees. Vertical and lateral translations are direct and efficient.

The six degrees of freedom embodiment is shown in FIG. 2. A longitudinal translation assembly adds longitudinal translation to the five degrees of freedom embodiment. This longitudinal translation correlates to acceleration and braking in vehicle simulation.

The four degrees of freedom embodiment eliminates roll rotation. In this embodiment, a five degrees of freedom embodiment has the rear multi-axis pivot joint shaft B2 connected to end-effector 76 in a fixed, non-rotating fashion.

### BRIEF DESCRIPTION OF DRAWINGS

FIG. 1 five degrees of freedom embodiment, side view

FIG. 2 six degrees of freedom embodiment, side view

FIG. 3 front translation assembly, occupant platform side view

FIG. 4 front translation assembly, exterior view

FIG. 5 occupant platform, side view

FIG. 6 extension tube assembly, exploded view

FIG. 7 rear translation assembly, occupant platform side view

FIG. 8 rear translation assembly, exterior view

FIG. 9 prior art, U.S. Pat. No. 2,046,584, A. H. Rzeppa, universal joint longitudinal section

FIG. 10 prior art, U.S. Pat. No. 2,046,584, A. H. Rzeppa, universal joint cross section

FIG. 11 longitudinal translation assembly, top view

FIG. 12 five degrees of freedom embodiment, showing roll, pitch and yaw rotation

### REFERENCE NUMERALS IN DRAWINGS

21 front translation assembly
22 occupant platform
23 rear translation assembly
24 longitudinal translation assembly
25 vertical steel tube
26 horizontal steel tube
27 roller chain
28 roller chain
29 drive sprocket assembly
30 polyurethane u-groove idler wheel
31 idler sprocket assembly
32 drive sprocket
33 end-effector
34 idler sprocket assembly
35 drive sprocket assembly
36 vertical steel tube
37 horizontal truss lower tube
38 horizontal truss upper tube
39 first rotary actuator
40 second rotary actuator
41 extension tube
42 occupant platform frame
43 front floor panel
44 bottom floor panel
45 occupant platform door
46 door latch
47 upper door hinge
48 lower door hinge
49 left seat armrest
50 left seat side panel
51 four point harness
52 seat headrest
53 electronic simulator steering wheel
54 electronic simulator foot petals
55 seat back
56 electronic simulator steering wheel support
57 multi-axis pivot joint mounting hole
58 first translation mechanism
59 chain attachment bracket
60 deep groove bearing
61 spacer
62 retainer nut
63 third rotary actuator
64 fourth rotary actuator
65 horizontal truss upper tube
66 horizontal truss lower tube
67 drive sprocket assembly
68 vertical steel tube
69 horizontal steel tube
70 drive sprocket assembly
71 roller chain
72 chain attachment bracket
73 roller chain
74 second translation mechanism
75 shaft clearance hole
76 end-effector
77 horizontal spacing tubes
78 vertical steel tube
79 idler sprocket assembly
80 idler sprocket assembly
81 idler sprocket
82 third translation mechanism
83 fourth translation mechanism
84 roller chain
86 sprocket
87 drive sprocket
88 bearing block
89 bearing block bracket
90 fifth rotary actuator
91 longitudinal steel tube
92 lateral steel tube
93 roller chain
94 idler sprocket assembly
95 drive sprocket assembly
96 sixth rotary actuator
97 wheel bracket
98 steel foot
A inner spherical member
B shaft
C outer spherical socket
D shaft
E spherical cage
F balls
G registering meridian ball race grooves
H registering meridian ball race grooves

### DETAILED DESCRIPTION OF THE INVENTION

In this specification, “multi-axis pivot joint” may include any combination of: automotive type universal joints, Rzeppa joints, Birfield joints, constant velocity joints, ball joints, tie-rod joints, and functionally equivalent mechanisms.

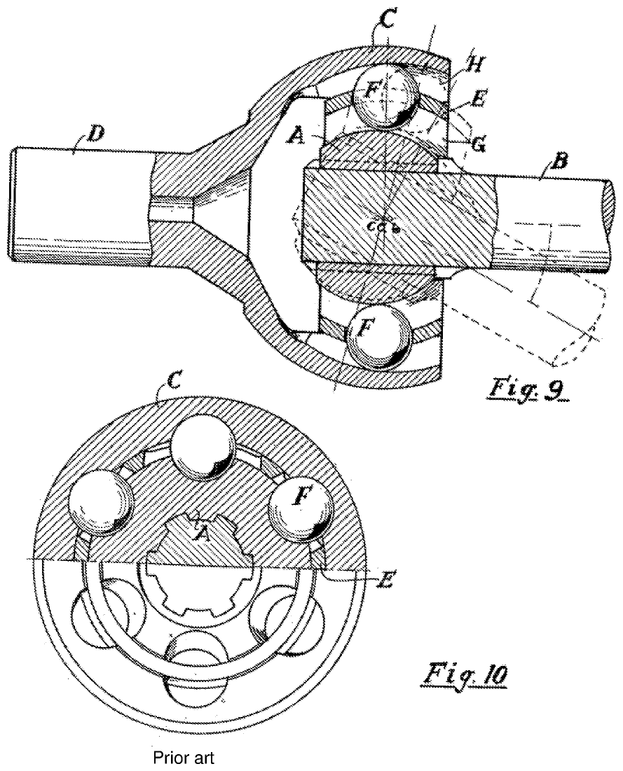

FIGS. 9 and 10 show prior art, U.S. Pat. No. 2,046,584, A. H. Rzeppa, 1936. This patent is for an improved universal joint. This mechanism is currently used for constant velocity joints in most automotive front wheel drive driveshafts. Constant velocity joints are shown as multi-axis pivot joints in this specification. All embodiments ignore shaft D (FIG. 9), and use the outer spherical socket C as the mechanical attachment point for the joint. FIG. 6 shows outer spherical socket C1 with shaft D removed.

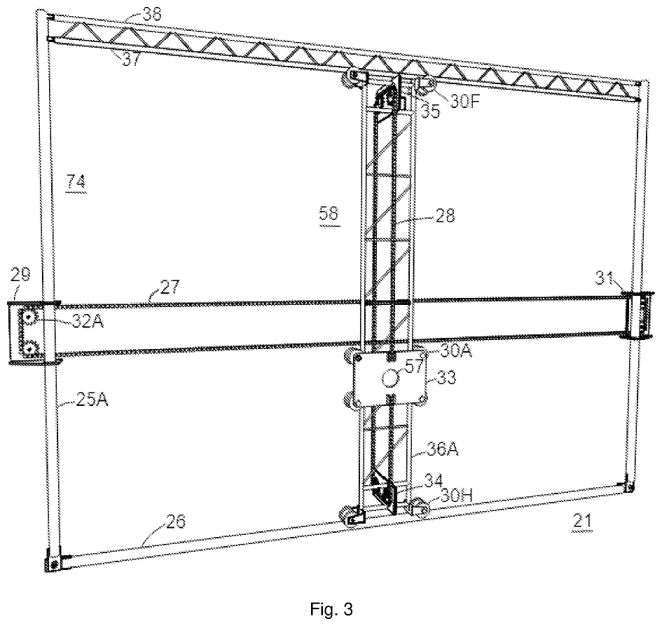

The front translation assembly is shown in FIG. 3. End-effector 33 contains multi-axis pivot joint mounting hole 57. This hole constrains outer spherical socket C1 mounted at the end of extension tube 41.

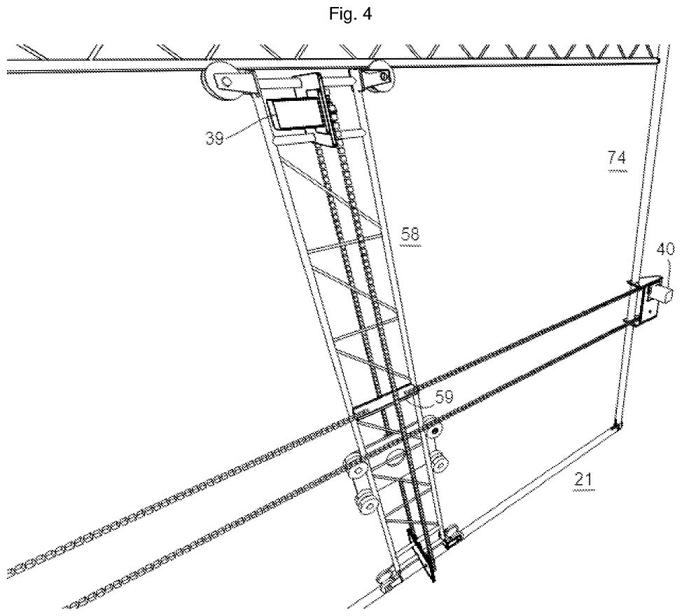

Four polyurethane u-groove idler wheels 30 are mounted on the four corners of end-effector 33. These wheels roll freely on ball bearings. These wheels captivate the end-effector 33 to the vertical steel tubes 36 of the first translation mechanism 58. These vertical steel tubes are held parallel by small diameter steel tubes creating a truss framework. One end of roller chain 28 is attached to the lower edge of the end-effector 33. Chain 28 extends down and couples to idler sprocket assembly 34 mounted at the bottom of the first translation mechanism 58. Chain 28 then returns up and couples to drive sprocket assembly 35 mounted at the top of the first translation mechanism. Chain 28 finally extends back down, and attaches to the top end of the end-effector 33. The drive sprocket in drive sprocket assembly 35 is driven by the first rotary actuator 39, best shown in FIG. 4.

Two polyurethane u-groove idler wheels 30 are mounted on the bottom of the first translation mechanism 58. These wheels are captivated by the horizontal steel tube 26 of the second translation mechanism 74. Connected at both ends of this steel tube are vertical steel tubes 25. The top of these vertical tubes are connected to a horizontal truss assembly. The lower beam 37 of this truss is captivated by two polyurethane u-groove idler wheels 30 mounted on the top of the first translation mechanism 58.

Chain attachment bracket 59, best shown in FIG. 4 is mounted to the midpoint of the vertical steel tubes 36 of the first translation mechanism 58. One end of roller chain 27 is attached to this chain attachment bracket. This chain extends horizontally outwards and couples to the idler sprocket assembly 31 mounted to one of the second translation mechanism 74 vertical steel tubes 25. This chain then returns horizontally back and couples to drive sprocket assembly 29. Finally, chain 27 returns horizontally to chain attachment plate 59. The drive sprocket of drive sprocket assembly 29 is attached to and is driven by the second rotary actuator 40. The second sprocket of drive sprocket assembly 29 is an idler sprocket.

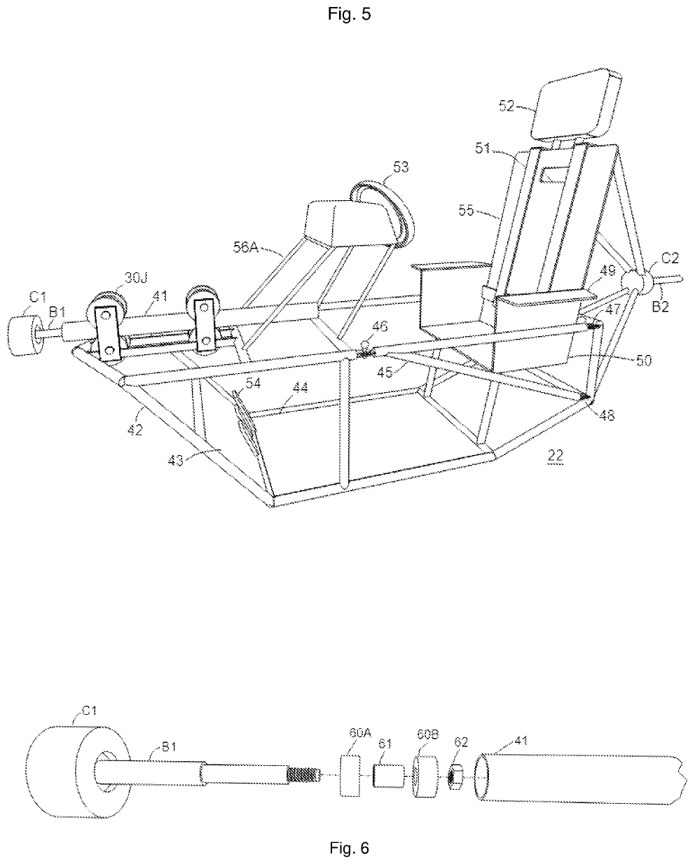

The occupant platform 22 shown in FIG. 5 is fabricated from welded thin wall steel tubing 42 and is roughly rectangular in shape. Two pairs of polyurethane u-groove idler wheels 30 mounted on the top and front of the occupant platform captivate extension beam 41.

Door frame 45 is attached to occupant platform 22 by hinges 47 and 48. Door latch 46 keeps door frame 45 closed during operation. Left seat armrest 49 and left seat side panel 50 are attached to door frame 45. Seat headrest 52 is attached to top of seat back 55. Four point harness 51 restrains the occupant during operation. Bottom floor panel 44 and front floor panel 43 enclose the bottom of occupant platform. Electronic simulator foot petals 54 and electronic simulator steering wheel 53 receive control input from occupant.

FIG. 6 shows outer spherical socket C1 of the front multi-axis pivot joint. Shaft B1 is constrained by deep groove bearings 60A and 60B. Spacer 61 and retainer nut 62 captivate the bearings on shaft B1. The outer races of bearings 60A and 60B are captivated inside extension tube 61.

Outer spherical socket C2 is mounted at the rear longitudinal endpoint of occupant platform 22. Shaft B2 couples to end-effector 76 of rear translation assembly 23.

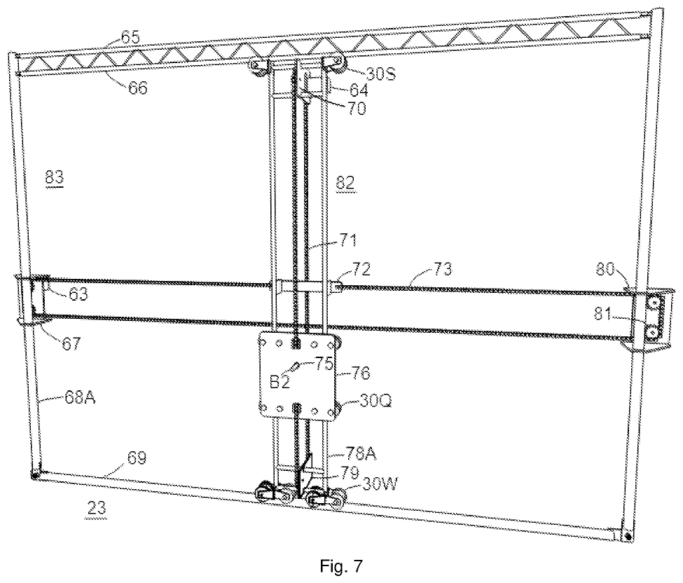

FIG. 7 shows the rear translation assembly 23. Shaft clearance hole 75 permits shaft B2 to pass through end-effector 76.

Four polyurethane u-groove idler wheels 30 are mounted on the corners of end-effector 76. These wheels captivate end-effector 76 to the vertical steel tubes 78 of the third translation mechanism 82. One end of roller chain 71 is attached to the bottom edge of the end-effector. Chain 71 extends downward and couples to idler sprocket assembly 79 mounted at the bottom of the third translation mechanism 82. Chain 71 returns up and couples with drive sprocket assembly 70 mounted at the top of the third translation mechanism. Chain 71 extends back down, and is attached to the top edge of end-effector 76. The drive sprocket in drive sprocket assembly 70 is driven by the fourth rotary actuator 64.

Four polyurethane u-groove idler wheels 30 are mounted on the bottom of the third translation mechanism 82. These wheels captivate the horizontal steel tube 69 of the fourth translation mechanism 83. Connected at both ends of this steel tube are vertical steel tubes 68. The top of these vertical tubes are connected to a horizontal truss assembly. The beam 66 of this truss is captivated by two polyurethane u-groove idler wheels 30 mounted on the top of the third translation mechanism 82.

Chain attachment bracket 72 is mounted to the midpoint of the vertical steel tubes 78 of the third translation mechanism 82. One end of roller chain 73 is attached to this chain attachment bracket. This chain extends horizontally outwards and couples to the idler sprocket assembly 80 mounted to one of the vertical steel tubes 68. Chain 73 then returns horizontally back and couples to drive sprocket assembly 67. Finally, chain 73 returns horizontally and is attached to the chain attachment plate 72. The drive sprocket of drive sprocket assembly 67 is attached to and driven by third rotary actuator 63. The lower sprocket of drive sprocket assembly 67 is an idler sprocket.

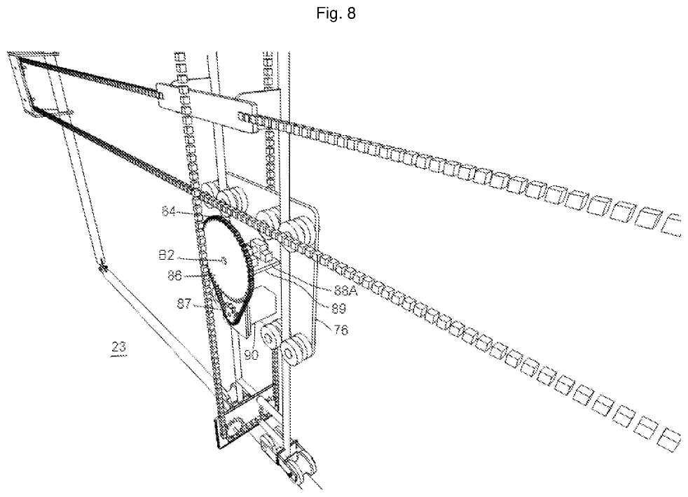

FIG. 8 shows an exterior view of rear translation assembly 23. Bearing block bracket 89 is mounted to end-effector 76. Bearing blocks 88A and 88B are mounted on this bearing block bracket. Rear multi-axis pivot joint shaft B2 is constrained by bearing blocks 88A and 88B. Sprocket 86 is mounted on the end of shaft B2. Roller chain 84 couples sprocket 86 to drive sprocket 87. Drive sprocket 87 is mounted to and driven by the fifth rotary actuator 90.

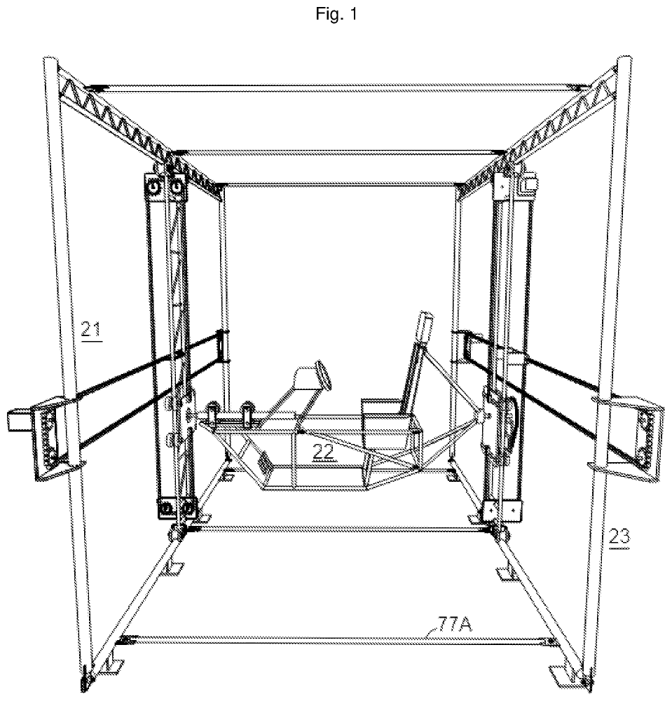

FIG. 1 shows three horizontal spacing tubes 77 attached perpendicularly between steel tubes 26 and 69. Three horizontal spacing tubes 77 are attached perpendicularly between the upper steel tubes 38 and 65.

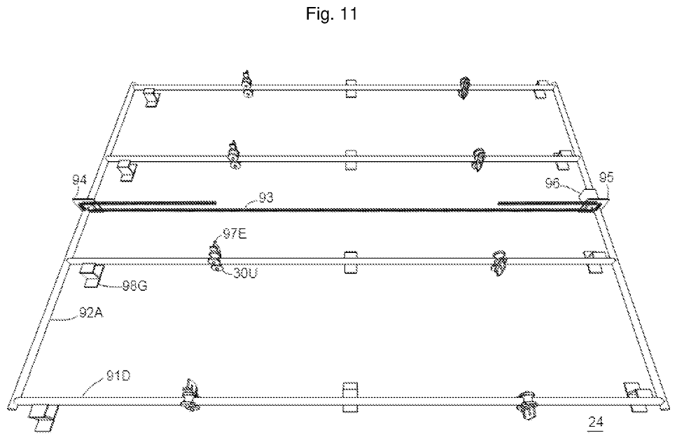

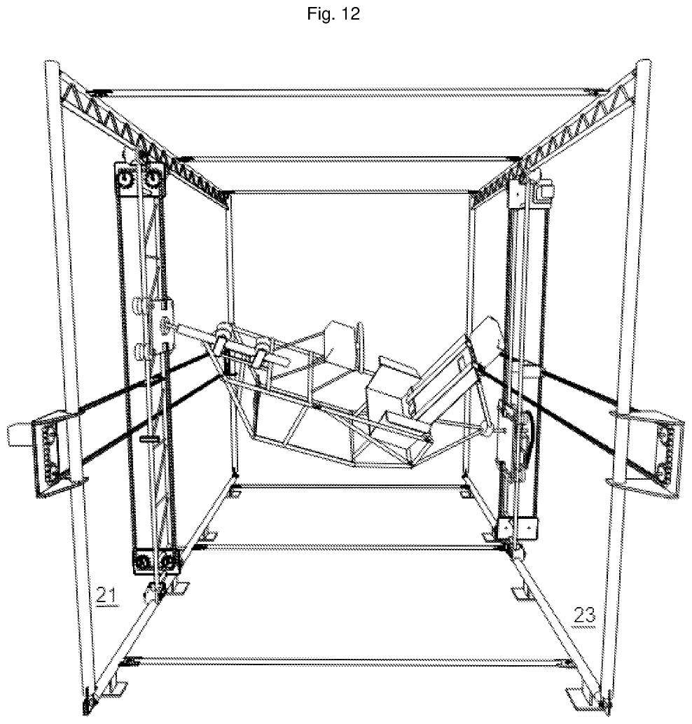

FIG. 11 is a top view of the longitudinal translation assembly 24. Four wheel brackets 97 mount to the bottom horizontal steel tube 26 of the front translation assembly 21. Four wheel brackets 97 mount to the bottom horizontal steel tube 69 of the rear translation assembly 23. Each of the eight wheel brackets 97 have a vertically oriented pair of polyurethane u-groove idler wheels 30. The longitudinal steel tubes 91 are each captivated by two pairs of idler wheels 30. Each end of the four longitudinal steel tubes 91 connect perpendicularly to the two lateral steel tubes 92. Each of the four longitudinal steel tubes 91 are supported by three steel feet 98.

Roller chain 93 is attached to horizontal steel tube 26 of the front translation assembly 21. Chain 93 extends out horizontally, and couples to idler sprocket assembly 94. Chain 93 then runs horizontally and couples to drive sprocket assembly 95. Finally, chain 93 extends to and is attached to horizontal steel tube 69 of the rear translation assembly 23. The drive sprocket of drive sprocket assembly 95 is attached to and driven by the sixth rotary actuator 96.

### Operation

Five degrees of freedom embodiment: The occupant platform 22 shown in FIG. 5 is a lightweight platform designed for maximum dynamic performance. Occupant platform door 45 swings out providing ingress and egress. The occupant is restrained by a four point harness 51. A wireless VR headset (not shown) provides graphics input to the occupant. Control inputs include simulator steeling wheel 53, and petals 54.

The occupant platform is supported and articulated by the front and rear mechanical assemblies. The front and rear mechanical assemblies are held vertical and parallel to each other by six spacing tubes 77. All six rotary actuators would typically be servo motors.

The front end of the occupant platform is supported and articulated by the front translation assembly FIG. 3. Extension beam 41, FIG. 6, is coupled to the end-effector 33 by outer spherical socket C1. Bearings 60A and 60B allow shaft B1 to freely rotate on its longitudinal axis, but otherwise constrains its position within extension beam 41. Shaft B1 rotates due to occupant platform roll force being applied through the rear multi-axis pivot joint. Extension beam 41 extends in and out depending on the amount of occupant platform pitch and yaw present.

The vertical position of end-effector 33 is controlled by rotary actuator 39. The horizontal position of end-effector 33 is controlled by rotary actuator 40.

The rear end of occupant platform 22 is supported and articulated by the rear translation assembly shown in FIG. 7. Since the center of mass for the occupant platform is oriented toward the rear, the rear translation assembly would typically require increased structural strength and more powerful rotary actuators than the front translation assembly.

The vertical position of end-effector 76 is controlled by rotary actuator 64. The horizontal position of end-effector 76 is controlled by rotary actuator 63.

FIG. 8 shows the components that control occupant platform roll. The rear multi-axis pivot shaft B2 passes through end-effector 76, and is constrained by bearing blocks 88A and 88B. Sprocket 86 mounts to the end of shaft B2. Sprocket 86 is coupled to sprocket 87 by roller chain 84. Rotary actuator 90 drives sprocket 87, and ultimately controls occupant platform roll rotation.

Alternates to roller chains 27, 28, 71, 73, and 93 and their sprockets include ball screws, acme screws, synthetic rope with pulleys, v-belts with pulleys, cog drive belts with pulleys, rack and pinion gearing, linear actuators, linear motors, pneumatic cylinders, hydraulic cylinders, and functional equivalents to generate linear motion.

Alternates to roller chain 84, sprocket 86 and sprocket 87 include synthetic rope with pulleys, v-belts with pulleys, cog drive belts with pulleys, and functional equivalents to transfer rotational energy.

Alternates to roller chain 84, sprocket 86, sprocket 87, and rotary actuator 90 include gear motors, hydraulic motors, pneumatic motors, and functional equivalents to generate rotational motion.

Occupant platform 22 roll rotation is produced by rotary actuator 90. Occupant platform 22 lateral motion (sway) is produced by coordinated activation of rotary actuators 40 and 63. Occupant platform 22 vertical motion (heave) is produced by coordinated activation of rotary actuators 39 and 64.

Occupant platform 22 pitch is controlled by the relative vertical positions of end-effectors 33 and 76. Occupant platform 22 yaw is controlled by the relative horizontal positions of end-effectors 33 and 76. Occupant platform 22 can be articulated to any simultaneous combination of roll, pitch, yaw, heave, and sway within mechanical limits.

Four degrees of freedom embodiment: This embodiment eliminates roll rotation. Shaft B2 of the rear multi-axis pivot joint is fixed to end-effector 76. This is implemented by replacing bearing blocks 88A and 88B with clamping blocks. Rotary actuator 90 and associated drive components are eliminated. Due to the decrease in inertial mass, the sway, heave, pitch, and yaw dynamics of the occupant capsule may be improved.

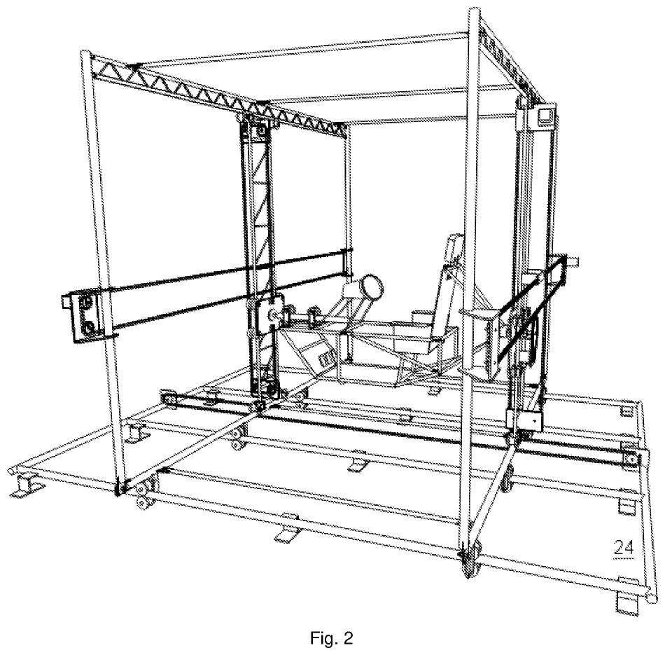

Six degrees of freedom embodiment: The longitudinal translation assembly (FIG. 11), is mounted to the bottom of the five degrees of freedom embodiment. This results in the six degrees of freedom embodiment shown in FIG. 2. Each of the eight wheel brackets 97 support two polyurethane u-groove idler wheels 30. Each pair of wheels captive one of the four longitudinal steel tubes 91. Twelve steel feet 98 elevate the longitudinal steel tubes 91 above the floor providing clearance for the wheel brackets and wheels. Roller chain 93 is attached to the horizontal steel tubes at the bottom of the front translation assembly 21, and the rear translation assembly 23. Rotary actuator 6 drives chain 93, producing longitudinal translation of the supported five degrees of freedom embodiment. In the six degrees of freedom embodiment, occupant platform 22 can exhibit any simultaneous combination of roll, pitch, yaw, heave, sway, and surge within mechanical limits.

FIG. 5 shows a lightweight single seat occupant platform intended for use with a wireless VR headset. Alternatives of this occupant platform include multiple occupant seats, an outer shell enclosing one or more occupants, and one or more display panels. Full replications of cockpits or vehicle cabins with operator controls can provide for comprehensive training for specific aircraft, vehicles, and vessels.

Alternative seating configurations include motorcycle or jet ski style seating. Alternative materials for the occupant platform include aluminum, metal alloys, polymers, carbon-fiber, fiberglass, and other composites.

Simulators linked using a low latency network can be used to simulate large aircraft, vehicles, or vessels with multiple positions for pilots, drivers, and operators.

A Birfield joint is essentially an improved Rzeppa joint wherein converging ball tracks do not rely on a controlled ball cage to maintain the intermediate ball members on the median plane.

When designing for heavy occupant platforms, it might be necessary to use large traditional cross beam universal joints due to the concentration of forces.

### CONCLUSION

All embodiments of the present invention provide high dynamic performance by minimizing inertial mass.

1. A motion generating machine, comprising:
(a) an occupant platform with locations for one or more occupants,
(b) two vertically oriented multi-axis translation mechanisms,
(c) two multi-axis pivot joints,
(d) said multi-axis pivot joints being any combination of Rzeppa joints, Birfield joints, constant velocity joints, yoke and spider universal joints, ball joints, tie-rod joints, spherical bearings, hinges, and functionally equivalent mechanisms,
(e) first end of each said multi-axis pivot joint attached to one longitudinal endpoint of said occupant platform,
(f) second end of each said multi-axis pivot joint attached to one said vertically oriented multi-axis translation mechanism,
(g) one or more actuators of said vertically oriented multi-axis translation mechanisms being capable of simultaneous multi-axis translation of attached said multi-axis pivot joints,
(h) a control system controlling actuator(s) of said vertically oriented multi-axis translation mechanisms,
(i) a graphics system capable of generating images viewable by occupant(s) using head mounted displays or flat panel displays, and
(j) said vertically oriented multi-axis translation mechanisms, and said multi-axis pivot joints providing mechanical support, rotation, and translation of said occupant platform in any combination of pitch, roll, yaw, heave, and sway.

2. The machine of claim 1 wherein said occupant platform cannot be rotated around its longitudinal axis.

3. The machine of claim 1 wherein said occupant platform can be partially rotated around its longitudinal axis by one or more actuators.

4. The machine of claim 1 wherein said occupant platform can be rotated around its longitudinal axis in unlimited amounts by one or more actuators.

5. A motion generating machine, comprising:
(a) an occupant platform with locations for one or more occupants,
(b) two vertically oriented multi-axis translation mechanisms,
(c) two multi-axis pivot joints,
(d) said multi-axis pivot joints being any combination of Rzeppa joints, Birfield joints, constant velocity joints, yoke and spider universal joints, ball joints, tie-rod joints, spherical bearings, hinges, and functionally equivalent mechanisms,
(e) first end of each said multi-axis pivot joint attached to one longitudinal endpoint of said occupant platform,
(f) second end of each said multi-axis pivot joint attached to one said vertically oriented multi-axis translation mechanism,
(g) one or more actuators of said vertically oriented multi-axis translation mechanisms being capable of simultaneous multi-axis translation of attached said multi-axis pivot joints,
(h) a control system controlling actuator(s) of said vertically oriented multi-axis translation mechanisms,
(i) a graphics system capable of generating images viewable by occupant(s) using head mounted displays or flat panel displays,
(j) said vertically oriented multi-axis translation mechanisms being attached to a longitudinal translation mechanism,
(k) one or more actuators of said longitudinal translation mechanism being capable of translation of said vertically oriented multi-axis translation mechanisms, and said occupant platform,
(l) a control system controlling actuator(s) of said longitudinal translation mechanism, and
(m) said longitudinal translation mechanism, and said vertically oriented multi-axis translation mechanisms, and said multi-axis pivot joints providing mechanical support, rotation, and translation of said occupant platform in any combination of pitch, roll, yaw, heave, sway, and surge.

6. The machine of claim 5 wherein said occupant platform cannot be rotated around its longitudinal axis.

7. The machine of claim 5 wherein said occupant platform can be partially rotated around its longitudinal axis by one or more actuators.

8. The machine of claim 5 wherein said occupant platform can be rotated around its longitudinal axis in unlimited amounts by one or more actuators.
